(19) United States
(12) Patent Application Publication
(10) Pub. No.: US 2013/0221100 A1
(43) Pub. Date: Aug. 29, 2013

(54) Adapter

(71) Applicant: Control Techniques Ltd, (US)

(72) Inventors: Jonathan Robert Holman, Shrewsbury (GB); Richard Mark Wain, Newtown (GB)

(73) Assignee: CONTROL TECHNIQUES LTD, Newtown (GB)

(21) Appl. No.: 13/779,346

(22) Filed: Feb. 27, 2013

(30) Foreign Application Priority Data
Feb. 29, 2012 (GB) 1203574.7

(51) Int. Cl. G06K 7/01

(52) U.S. Cl. CPC G06K 7/01
USPC 235/441; 235/492

(57) ABSTRACT

An adapter is provided for adapting a Secure Digital (SD) card for use with a Smart Card reader. The adapter comprises an improved Smart Card with a memory device physically connected thereto. A controller may also be provided for use with the Smart Card reader, the controller being configured to identify whether a conventional Smart Card or an adapter that includes an SD card socket has been presented to the Smart Card reader. The controller may be arranged to control communication between the Smart Card reader and an SD card in the SD card socket and to control access to the SD card memory accordingly.

### CROSS-REFERENCE TO RELATED APPLICATION

This application claims the benefit and priority of Great Britain Patent Application No. GB 1203574.7 filed Feb. 29, 2012. The entire disclosure of the above application is incorporated herein by reference.

### FIELD

The invention relates to an adapter for use with a Smart Card reader. It further relates to reading information stored on such an adapter.

### BACKGROUND

Smart Cards are well known and have many uses. In general, a Smart Card (which might also be referred to as a chip card or integrated circuit card) comprises a relatively small (usually wallet sized) card with one or more integrated circuits embedded therein. The integrated circuits on a Smart Card generally include some memory and a microprocessor. Smart Cards are generally used in conjunction with a Smart Card reader. Often data stored in the Smart Card memory is used by the Smart Card reader for user authentication and/or identification purposes. For example, commonly used Smart Cards include “chip and pin” credit and banking cards. Smart Cards may also be used for prepayment purposes for a wide range of commodities including household utilities, public transport and public telephones. They can also be used to control user access, in either a physical and/or a logical sense. For example a user may have to insert a Smart Card into a Smart Card reader in order to gain access to a building or to access information on a computer or network or to enable operation of equipment such as electrical equipment that can only be used by authorised users in accordance with its particular policy or set of rules.

Smart Card readers are also well known and widely used. Generally speaking, Smart Card readers include a Smart Card interface for receiving a Smart Card. For Smart Card readers that require physical contact with the Smart Card, the interface will normally include a slot or other opening into which some or all of a Smart Card can be inserted (at least the part of the Smart Card that contains the integrated circuit which is to be read by the Smart Card reader must be inserted). The Smart Card reader, or another device provided in conjunction with that Smart Card reader, also includes suitable processing means for interacting with the Smart Card, which usually involves reading information from the Smart Card memory. It is also possible to provide contactless Smart Cards for which no physical contact between the Smart Card and Smart Card reader is required. Communication between a contactless Smart Card and associated reader can be controlled by the Smart Card reader for example through radio frequency (RF) induction technology.

It will thus be understood that Smart Cards are highly useful devices whilst at the same time being compact and relatively easy to manufacture. Therefore the use of Smart Card technology is often desirable. However a drawback of existing Smart Card technology is that memory space on existing Smart Cards is limited. There is currently no technology available that addresses this drawback in an efficient or cost effective manner.

### SUMMARY

An invention is set out in the claims.

According to an aspect, an adapter is provided. The adapter comprises an improved Smart Card, wherein the Smart Card has a memory device physically connected thereto.

The memory device may be permanently or removably connected to the adapter. The adapter may comprise a socket arranged to receive the memory device. The received memory device may be a Secure Digital (SD) card.

The adapter may comprise an integral electronic chip having a chip interface provided on a first face, wherein the memory device is attached to a second face of the adapter, opposite said first face.

The adapter may comprise the chip interface without an integral electronic chip.

According to an aspect a controller is provided for use with a Smart Card reader, the controller being configured to distinguish between a first memory type and a second memory type, when a card comprising a memory is presented to the Smart Card reader.

The controller may comprise a microcontroller. The controller may be integral to the Smart Card reader or may be physically separate thereto. It may be provided physically proximal to or remote from the Smart Card reader.

The first memory type may include a memory comprised within an integral electronic chip on a Smart Card. The second memory type may include a memory comprised within a Secure Digital (SD) card.

The controller may be configured to distinguish between the first memory type and the second memory type when the card comprising a memory is inserted into a Smart Card interface within the Smart Card reader.

According to an aspect an adapter is provided for adapting a Secure Digital (SD) card for use with a Smart card reader.

According to an aspect a method is provided for accessing memory on a Secure Digital (SD) card using a conventional Smart Card reader, the method including presenting a card that physically resembles a conventional Smart Card and that includes an integral electronic chip to the reader, wherein the reader accesses the memory on the Secure Digital (SD) card via said chip.

According to an aspect a method is provided for accessing memory on a Secure Digital (SD) card using a Smart Card reader, the method including presenting a card that physically resembles a conventional Smart Card and that includes a smart card interface comprising input and output pins to the reader, wherein the reader accesses the memory on the Secure Digital (SD) card via said input and output pins.

### FIGURES

Embodiments and examples will now be described with reference to the figures of which:

FIG. 1 is a front view of an adapter for use with a Smart Card reader;

FIG. 2 is a rear view of the adapter of FIG. 1;

FIG. 3 shows an assignment of pins (or “pin out”) for a Smart Card;

FIG. 4 shows an assignment of pins (or “pin out”) for an SD card;

FIG. 5 shows a circuit configuration for microcontroller interfaces with a Smart Card and a Smart Card/SD card adapter; and

FIG. 6 shows logic conditions for a microcontroller such as the one depicted in FIG. 5 when used in conjunction with a Smart Card or Smart Card/SD card adapter

### OVERVIEW

In overview, a card that effectively comprises an improved Smart Card with enhanced memory capacity is provided. Means for communicating with the improved Smart Card is also provided.

A secure digital (SD) card is utilised in order to enhance the memory capacity of the card (also referred to as the “adapter” herein) as compared to the memory capacity of a conventional Smart Card. The use of an SD card allows the storage of significantly greater amounts of electronic data than is possible using the integral electronic chip on a conventional Smart Card.

The adapter is provided in the form of a printed circuit board (PCB) with an integral electronic chip and with dimensions substantially identical to the dimensions of an existing conventional Smart Card, so that the adapter has an outline which suits use with an existing Smart Card reader.

Alternatively, the adapter may be provided in the form of a printed circuit board (PCB) with input and output pins or pads with dimensions substantially identical to the dimensions of an existing conventional Smart Card, so that the adapter has an outline which suits use with an existing Smart Card reader.

The adapter includes a socket or other receiver for receiving an SD card therein. The SD card may be permanently received in the socket or it may be removably received therein. When an SD card is received in the adapter, the adapter can communicate with a Smart Card reader, via the integral card chip and/or the input and output pins or pads on the adapter which act as a Smart Card-type interface, in order for the reader (or another device used in conjunction with that reader) to communicate with the SD card and to access data stored on the SD card. As a result, the relatively large memory capacity on the SD card is utilised but without having to change the interface at the Smart Card reader which is already configured to receive conventional Smart Cards.

At the Smart Card reader end, a processor such as a microcontroller can be provided to identify whether a conventional Smart Card or an adapter that includes an SD card socket has been presented to the Smart Card reader. Dependent on whether it identifies that: no card has been inserted; a Smart Card has been inserted; an adapter with the SD card absent has been inserted; or an adapter with an SD card received therein has been inserted in the Smart Card reader, the controller can control communication between the Smart Card reader and the relevant card and can control access to the relevant card memory accordingly.

### DETAILED DESCRIPTION

FIG. 1 shows an adapter 100. The adapter 100 comprises a printed circuit board (PCB) with an outline and physical dimensions that are substantially similar to a conventional Smart Card that can be used in conjunction with a conventional Smart Card reader. For example, dependent on the intended use of the adapter 100, its size and shape may be substantially identical to a conventional credit card, utility top up card or user identification/authentication card.

The main body 102 of the adapter 100 is usually made of plastic such as polyvinylchloride (PVC) however any suitable material may be used. The adapter comprises an integral electronic chip 104, the active part of which is embedded in the main body 102, and which has an input/output interface that is visible at least on the upper face of the adapter 100, preferably in the form of a smart card interface as shown in FIG. 1. The size of the chip 104 and its position on the main body 102 of the adapter 100 should be chosen at least in part based on the Smart Card reader with which the adapter 100 is to be used. It is intended that the slot or other receiver (generally referred to hereafter as an “interface”) on the Smart Card reader should not have to be adapted or replaced in order for that Smart Card reader to receive the adapter 100, having previously been designed and used for receiving conventional Smart Cards. Therefore if the Smart Card receiver (not shown in FIG. 1) is intended for receiving conventional credit cards, the adapter 100 should be designed so that the location and size of the chip 104 on its main body 102 is substantially identical to the corresponding location and size of the integral chip on a conventional credit card.

Alternatively, the adapter may comprise input and output pin connections in the form of a smart card interface comprising PCB pads having the same form factor and position as the chip 104.

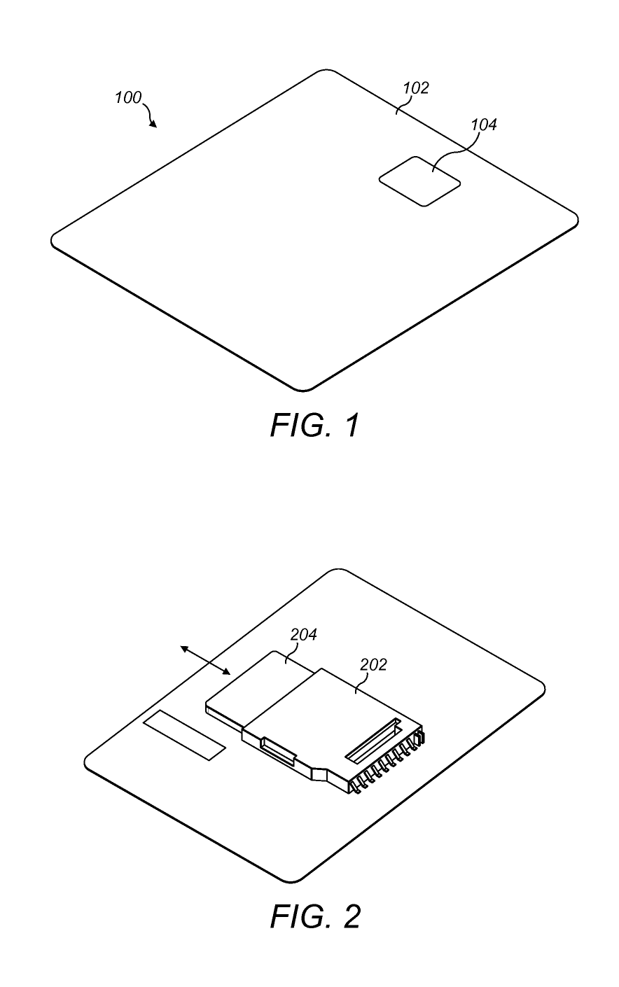

FIG. 2 shows a rear view of the adapter 100 shown in FIG. 1. The rear face of the adapter 100 includes a socket 202 for receiving a Secure Digital (SD) card. Also shown in FIG. 2 is an SD card 204 inserted into the socket 202, wherein the arrow in FIG. 2 illustrates the direction in which the SD card 204 should be moved in order to insert it into and remove it from the socket 202. In an alternative embodiment, the SD card 204 is not removable from the socket 202 and is thus permanently fixed to the main body 102 of the adapter 100.

When the SD card 204 is inserted in the socket 202, either permanently or on a removable basis, an electrical connection is formed that will enable data stored on the SD card 204 to be accessed when the adapter 100 is used in conjunction with a Smart Card reader. This electrical connection may be by way of tracks on the PCB of the adapter that connect input/output pins of the SD card socket to the smart card interface 104 of the adaptor. As a result, existing Smart Card reader technology can be used in conjunction with the SD card, thereby utilising the enhanced data storage capability of that SD card, without having to physically adapt or replace the Smart Card interface on that Smart Card reader. Furthermore, this solution enables the enhanced data storage capabilities of the SD card to be utilised in a safe manner for the user. As the skilled reader may be aware, a standard SD card does not offer sufficient isolation between its external surfaces and internal circuitry to provide a safe barrier between the user and the extra low voltage (ELV) circuits present on the control board of such a standard SD card. As a result, it is not possible for a user to touch or hold the outer surface of a conventional SD card when its contacts make an electrical connection with the contacts of a conventional SD card reader or holder. Because the adapter 100 as shown in FIGS. 1 and 2 herein is provided in the physical form of a Smart Card, with a socket 202 or a holder for an SD card comprised therewithin, the user can safely take hold of the main body 102 of the adapter 100 and insert it into a suitable Smart Card reader interface, without having to directly touch the SD card 204 that is housed in the socket 202 of the adapter 100.

As will be known to the skilled reader, both Smart Cards and SD cards comprise output pins. For example in a Smart Card the active part of the integral electronic chip may be embedded within the body of the card but will connect to (metal) output pins on an outer surface of the card. Communication between the active part of the chip and a Smart Card reader can be achieved via those output pins. The output pins on a Smart Card are usually provided within a relatively compact area such as the surface area of the chip 104 shown in FIG. 1 and may be provided in a variety of different physical configurations within such an area. One type of Smart card chip with which many readers will be familiar is the chip on a “SIM” card for a mobile telephone.

For SD cards, again the active components are generally embedded or encapsulated within a body and output pins which connect to those internal active components are provided on an external surface of the SD card. Usually the output pins on an SD card are provided in a substantially linear arrangement although this might not always be the case. One type of SD card with which many readers will be familiar is a memory card for use with digital cameras.

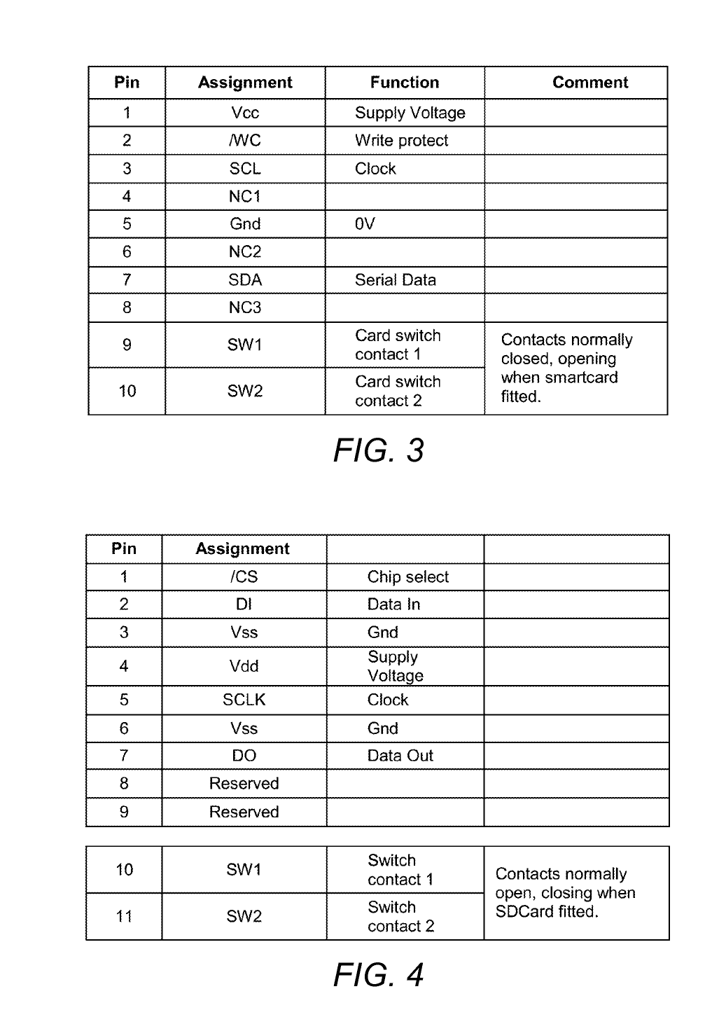

Commonly, the output pins on a conventional Smart Card will have a different assignment and/or function to the output pins on a conventional SD card. FIGS. 3 and 4 herein show examples of the possible assignment and function of output pins on a Smart Card and an SD card respectively. The Smart Card pin assignment includes three “not connect” (NC) pins. As can be seen therein, the assignment and function of the pins differ between the two devices. Therefore, even if an SD card and its output pins had the same physical form as a conventional Smart Card and its output pins, such an SD card could not simply be read by a conventional Smart Card reader that has conventional control electronics associated therewith. Furthermore, as is clear from the description above, in practice SD cards and Smart Cards are also physically different from one another, which adds additional complexity. As described above in relation to FIGS. 1 and 2, the adapter 100 overcomes the problem of there being physical differences between a conventional SD card and conventional Smart Card. Furthermore, the adapter 100 enables an electrical connection to be made so that information stored on the SD card can be accessed via a conventional Smart Card reader.

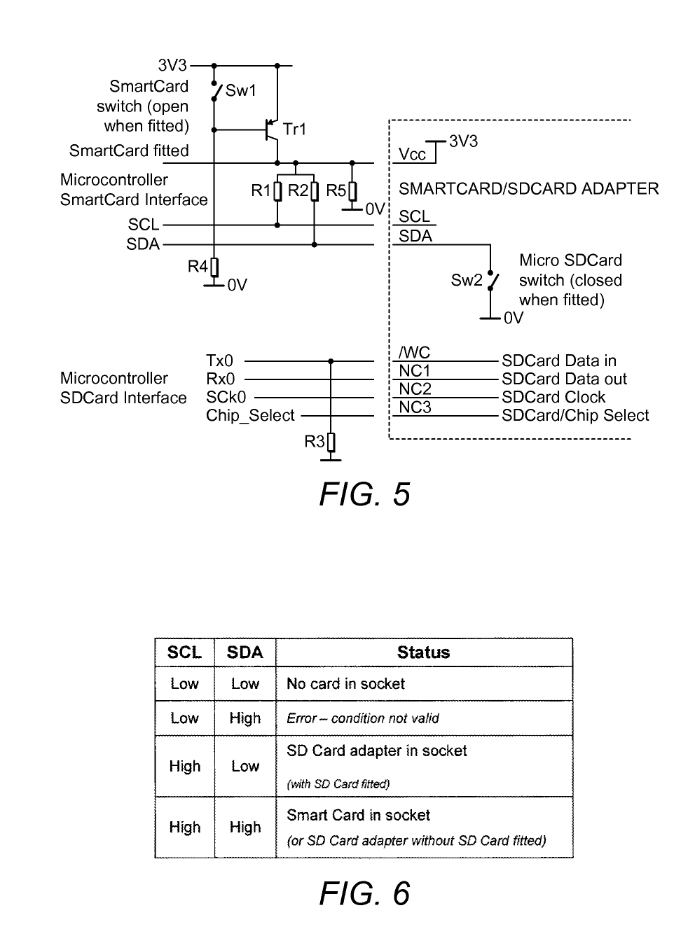

FIG. 5 shows a circuit configuration for a microcontroller that can be used in order to access the memory of an SD card using a conventional Smart Card interface on a Smart Card reader and an adapter such as the one shown in FIGS. 1 and 2 herein. The microcontroller may be provided integral to the Smart Card reader or may be physically separate therefrom. As is shown, four pins of the Smart Card interface (NC1, NC2, NC3 and /WC) on the adapter are arranged to be coupled to the SD card interface of the microcontroller.

The microcontroller can communicate both with a conventional Smart Card and with a Smart Card/SD card adapter such as the adapter 100 shown in FIGS. 1 and 2 herein. In operation, the microcontroller will monitor whether a card has been inserted into the Smart Card reader by monitoring the “Smart Card fitted” line as shown in the top left hand corner of FIG. 5. When neither a conventional Smart Card nor a Smart Card/SD card adapter is inserted in the reader, switch SW1 in the circuit will be in a closed state, meaning Tr1 will be off and the “Smart Card fitted” line will be held in a low state at 0V through resistor R5, shown in FIG. 5, and hence SCL and SDA are also held low. Also when there is no card inserted in the reader, the microcontroller should set its Tx0, Rx0, SCk0 and Chip_Select output pins of its SD card interface to their high impedance “input condition”, meaning that there can be no possible conflict with the “not connected” terminals on the Smart Card. Pull down resistor R3 will hold the /WC write protect line on the Smart Card in a low state.

When a conventional Smart Card is inserted in the Smart Card reader, switch SW1 as shown in FIG. 5 will have its contacts opened, meaning Tr1 switches on, providing a 3V3 power supply rail to the Smart Card and setting the “Smart Card fitted” line high, and hence SCL and SDA are also held high. The microcontroller should not change the setting of the Tx0, Rx0, SCk0 and Chip_Select pins when a conventional Smart Card is inserted.

When a Smart Card/SD card adapter is inserted in the Smart Card reader, but there is no SD card held by the adapter, the circuit shown in FIG. 5 will respond to indicate that a Smart Card has been installed, as described immediately above with respect to the insertion of a conventional Smart Card. However, because the adapter is not a conventional Smart Card and also has no SD card memory with which the reader can communicate, the microcontroller will be unable to communicate with the adapter card in this state and so an error condition can be generated.

If there is an SD card held within the Smart Card/SD card adapter and then the adapter is inserted into the Smart Card reader, switch SW1 will be opened, causing the “Smart Card fitted” line to go high and at the same time the switch on the adapter SW2 will be closed, as a result of which the SDA line in the top left hand portion of the circuit shown in FIG. 5 will be held low. In this state the microcontroller then activates its Tx0, Rx0, SCk0 and Chip_Select output pins so that it can then communicate with the SD card that is held by the adapter.

FIG. 6 is a table which shows the possible logic conditions for the microcontroller circuit described above in relation to FIG. 5. As can be seen therefrom, there is a unique respective logic condition, defined by the SCL and SDA lines of the smart card interface of the microcontroller in a circuit, for there being no card received by the Smart Card reader interface and for there being an adapter complete with SD card fitted therein received by the Smart Card reader. The logic condition for there being a Smart Card received by the reader is the same as the logic condition for there being an adapter without an SD card received by the Smart Card reader. However, as described above, the microcontroller can distinguish between those two events since it will be unable to communicate with the adapter in the absence of an SD card whereas it will be able to communicate with a conventional Smart Card.

Hence a straight forward yet highly useful solution is provided for creating and using a card that physically resembles a conventional Smart Card but has much greater memory capacity, and thus many more potential uses.

Whilst a particular embodiment has been shown and described in detail herein, it is not intended to be limiting and variations are possible. Any references to “first”, “second”, “left”, “right”, “front”, “back”, “upper” or “lower” herein are merely descriptive and refer to the orientation of the features as shown in the figures. They are not intended to be limiting.

1. A Smart Card having a memory device physically connected thereto.

2. A Smart Card as claimed in claim 1 wherein the memory device is removably connected to the Smart Card.

3. A Smart Card as claimed in claim 1 further comprising a socket arranged to receive the memory device.

4. A Smart Card as claimed in claim 1 wherein the memory device is a Secure Digital (SD) card.

5. A Smart Card as claimed in claim 1 comprising a smart card interface provided on a first face of the Smart Card, wherein the memory device is attached to a second face of the Smart Card, opposite said first face.

6. A Smart Card as claimed in claim 2 comprising a smart card interface provided on a first face of the Smart Card, wherein the memory device is attached to a second face of the Smart Card, opposite said first face.

7. A Smart Card as claimed in claim 3 comprising a smart card interface provided on a first face of the Smart Card, wherein the memory device is attached to a second face of the Smart Card, opposite said first face.

8. A Smart Card as claimed in claim 4 comprising a smart card interface provided on a first face of the Smart Card, wherein the memory device is attached to a second face of the Smart Card, opposite said first face.

9. A controller for use with a Smart Card reader, the controller being configured to distinguish between a first memory type and a second memory type when a card comprising a memory is presented to the Smart Card reader.

10. A controller as claimed in claim 9 wherein the controller comprises a microcontroller.

11. A controller as claimed in claim 9 wherein the first memory type includes a memory comprised within an integral electronic chip on a Smart Card.

12. A controller as claimed in claim 9 wherein the second memory type includes a memory comprised within a Secure Digital (SD) card.

13. A controller as claimed in claim 9, the controller being configured to distinguish between the first memory type and the second memory type when the card comprising a memory is inserted into a Smart Card interface within the Smart Card reader.

14. A controller as claimed in claim 10, the controller being configured to distinguish between the first memory type and the second memory type when the card comprising a memory is inserted into a Smart Card interface within the Smart Card reader.

15. A controller as claimed in claim 11, the controller being configured to distinguish between the first memory type and the second memory type when the card comprising a memory is inserted into a Smart Card interface within the Smart Card reader.

16. A controller as claimed in claim 12, the controller being configured to distinguish between the first memory type and the second memory type when the card comprising a memory is inserted into a Smart Card interface within the Smart Card reader.

17. An adapter for adapting a Secure Digital (SD) card for use with a Smart card reader.
